(19) United States
(12) Patent Application Publication
(10) Pub. No.: US 2014/0069950 A1
(43) Pub. Date: Mar. 13, 2014

(54) DISPENSING PACKAGE

(71) Applicants: George Martin Mason, Haddonfield, NJ (US); Harold Matson Zimmermann, Duck Key, FL (US); Marc Matthew Sirockman, Flemington, NJ (US)

(72) Inventors: George Martin Mason, Haddonfield, NJ (US); Harold Matson Zimmermann, Duck Key, FL (US); Marc Matthew Sirockman, Flemington, NJ (US)

(21) Appl. No.: 13/610,752

(22) Filed: Sep. 11, 2012

(51) Int. Cl. A61J 1/03

(52) U.S. Cl. CPC A61J 1/035
USPC 221/1; 206/531

(57) ABSTRACT

A dispensing system and method of use having a package and insert containing clinical information, wherein the package insert cannot be easily discarded, lost or damaged. The package insert is further configured so as to not impede closing of the packaging. The dispensing system further provides that mediation retained in the package cannot be removed from the package without partially removing the insert configured as an educational slider, such that the access to the medication is a ‘two-step’ process. In a further aspect, the dispensing system provides dosage instructions and other clinical information specific to the medication. The dispensing system may include sample or prescribed medication. Alternatively, the dispensing system may include a discount price coupon or other promotional material that is only accessible when an educational package insert is moved to provide access to the coupon or promotional material.

### BACKGROUND OF THE INVENTION

The present invention relates to the field of packaging, and particularly to devices, systems and methods for containing and dispensing items. The present invention is more particularly directed to a safer and smarter package for dispensing medication samples, such as pills, tablets and capsules. The present invention is further directed to a more secure package for dispensing promotional material, such as coupons and vouchers.

Heretofore, pharmaceutical companies provided physicians with samples of their medications (for example, medicaments or prescription drugs in pill, tablet and capsule form) to be distributed, free of charge, to prospective patients. This practice allowed both patient and physician to feel comfortable with the therapeutic benefit of the medication versus any side effects that may be encountered. After the sample medication had been exhausted, it was expected that the patient would fill a prescription and begin taking the medication as instructed by his/her physician and the medication instructions.

One disclosed package for retaining and dispensing items is formed from a flat pocket configured with a foldable element and one or more retractable panels. Each retractable panel is able to assume a deployed position in which an article in the package is visible and accessible. Each retractable panel is further able to assume a non-deployed position in which the item is invisible and inaccessible. The flat pocket is configured to form a front flap and a rear flap. Each retractable panel is attached to and movable relative to the front or rear flap. The articles are positioned in the package adjacent the rear flap so as to be dispensed through the retractable panel. Such devices are typically configured to provide a packaging configuration that does not open in the traditional way so as to frustrate any attempt by a child to open the package, while being easy to open for an adult. Such devices, however, were not known to be configured with educational material or configured to dispense medication or promotional material.

It has been shown that educational material (for example, a ‘Package Insert’) configured with a medication dispensing system is rarely read, and even less frequently understood, by the patient. There is typically no ‘patient-friendly’ education material that is given with the medication sample, and even when educational materials are provided, they are typically given in a loose manner, i.e., not connected to the sample. The physical packaging is typically a translucent, amber bottle or a simple blister-pack. This combination does not promote safe, easy sampling by well-informed patients. Such devices fail to produce the best health outcome for the patient and the revenue-maximizing outcome for the pharmaceutical company.

Accordingly, there is a need for, and what was heretofore unavailable, an integrated dispensing package, system and method of use that requires the user to view educational and/or marketing information to access an item and/or promotional material contained in the dispensing package. The present invention satisfies these and other needs.

### SUMMARY OF THE INVENTION

Briefly, and in general terms, the present invention is directed to devices (apparatus), systems and methods for dispensing items, such as medication (for example, pills, tablets, capsules) and promotional materials (for example, coupons and vouchers) in an informative and effective dispensing package. The present invention is further directed to dispensing packaging having a Package Insert containing clinical information, wherein the Package Insert cannot be discarded, lost or damaged. The Package Insert may be configured so as to not impede closing of the packaging. In another aspect, the invention further provides that the mediation or coupon (voucher) cannot be dispensed without partially or fully removing a Package Insert configured as an educational slider, such that the access to the medication or coupon (voucher) is a ‘two-step’ process. In a further aspect, the invention provides dosage instructions and other clinical information on the packaging regarding medication of interest to a user.

The present invention provides a system for dispensing medication, including a package having a first (front) portion and a second (back) portion, wherein the first portion (card) is configured to be moved adjacent the second portion (card). The second card is configured with a first opening (window), a slider configured to be retained with a pocket of the second card, and a medication retainer partially disposed within the pocket. The slider is configured to extend in a first direction to allow medication to be removed from the retainer through the first opening of the second portion of the package. The mediation retainer may be configured as a ‘blister-pack’ made from any suitable material, for example, but not limited to, metal foil or plastic wrap.

The first and second card and/or slider may be printed with or otherwise configured with educational information relating to the medication to be dispensed. In addition, the second portion of the package may be configured with a second opening (window) so as to provide educational information relating to the medication that is printed on the slider to be viewed though the second opening. Further, a second side of the slider may include additional product and/or manufacturer information provided as written text, linear barcode, matrix barcode (two-dimensional code) or other format that is visible through the window in the front card. The slider and pocket may be configured with a latch mechanism to prevent the slider from being removed from the pocket.

The present invention is further directed to a package having a first portion (card) and a second portion (card), wherein the first card is configured to be moved adjacent the second card. The second card is configured with a removable promotional material portion and is configured with a pocket for removably retaining a slider. The slider is configured to extend in a first direction to allow the promotional material portion (redemption item) to be removed from the second card of the package. The promotional material portion may include a price discount coupon, voucher and/or other redemption item. The packaging may include printed and graphic information relevant to the promotional material.

Other features and advantages of the present invention will become apparent from the following detailed description, taken in conjunction with the accompanying drawings, which illustrate, by way of example, the features of the system, device and method of use.

### BRIEF DESCRIPTION OF THE DRAWINGS

FIG. 1 is a front perspective view of an embodiment of a dispensing package of the present invention.

FIG. 2 is a rear perspective view of an embodiment of a dispensing package of the present invention.

FIG. 3 is a front plan view of a dispensing package configured with a medication blister-pack and configured with an educational slider fully contained in a portion of the dispensing package in accordance with the present invention.

FIG. 4 is a front plan view of a dispensing package configured with a medication blister-pack and configured with an educational slider partially extended from a portion of the packaging to allow medication to be removed from the dispensing package in accordance with the present invention.

FIG. 5 is a cross-sectional view of a medication dispensing package taken along line 5-5 of FIG. 3.

FIG. 6 is a cross-sectional view of a the medication dispensing package of the present invention taken along line 6-6 of FIG. 4.

FIG. 7 is a rear perspective view of a medication dispensing package of the present invention, wherein an educational slider is extended to allow medication to be removed from retainer material disposed within the package.

FIG. 8 is a rear perspective view of an embodiment of a promotional information dispensing package in accordance with the present invention.

FIG. 9 is a front plan view of the inside portion of an embodiment of a promotional material dispensing package of the present invention, wherein an educational slider is fully contained within a lower portion of the package.

FIG. 10 is a front plan view of the inside portion of an embodiment of a promotional material dispensing package of the present invention, wherein an educational slider is shown partially extended from a lower portion of the package to provide access to a redemption item.

FIG. 11 is a rear perspective view of an embodiment of the present invention, wherein a redemption item has been removed from the package.

### DETAILED DESCRIPTION OF THE INVENTION

As shown in the drawings for purposes of illustration, the present invention is directed to a dispensing package (apparatus) and system having a slider mechanism for removably retaining a material, such as a medication dispenser, product information or redemption item, such as a discount coupon. The present invention is further directed to a dispenser having a Package Insert containing clinical information, wherein the Package Insert cannot be easily discarded, lost or damaged. The Package Insert is further configured so as to not impede closing of the packaging. In another aspect, the invention further provides that mediation or a redemption item can only be dispensed by partially or fully removing the Package Insert configured as an educational slider, such that the access to the medication or redemption item is a ‘two-step’ process. In a further aspect, the invention provides dosage instructions and other clinical information on the package regarding the relevant medication.

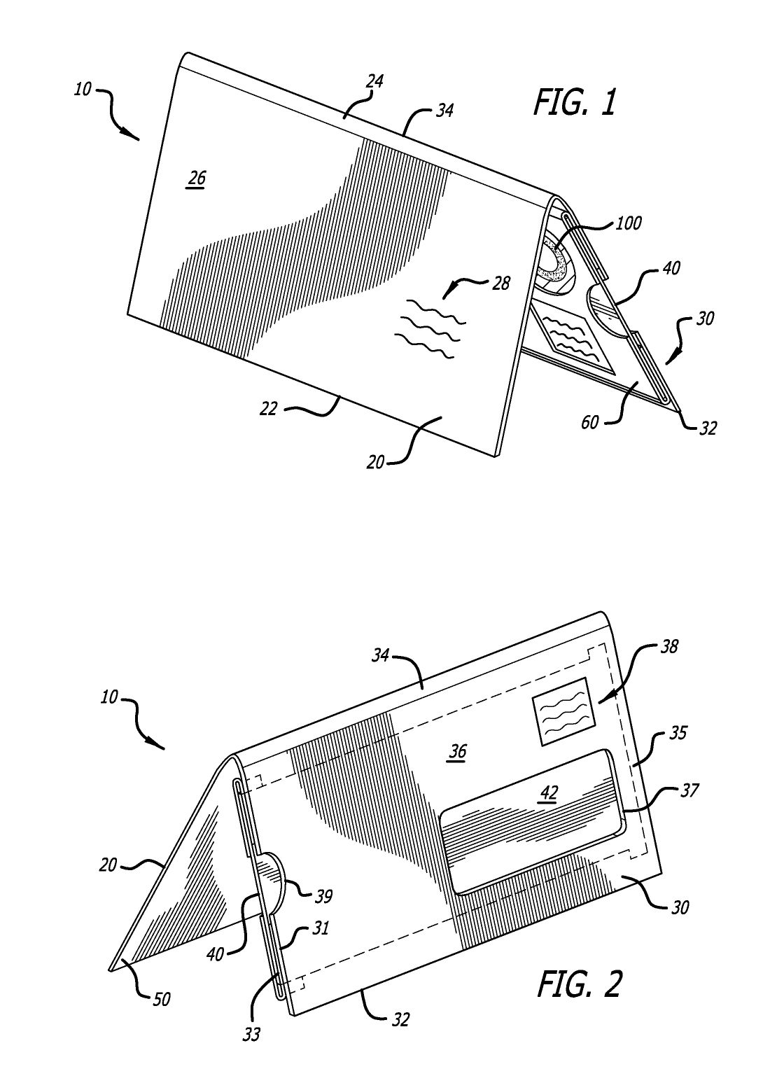

Turning now to the drawings, in which like reference numerals represent like or corresponding aspects of the drawings, and with particular reference to FIG. 1, the dispensing system 10 includes a package formed with a first portion (front card) 20 and a second portion (back card) 30. The first portion of the package has a first (bottom) edge 22 and a middle section 24 transverse the bottom edge. The second portion of the package has a first (bottom) edge 32 and a middle section 34 transverse its bottom edge. The middle portions of the front card and back card are longitudinally positioned adjacent to each other. The first and second portions of the dispensing package may be formed as a unitary body folded in the middle such that the first edge of the front card is adjacent the first edge of the back card when the package is in a closed position. Alternatively, the first and second portions of the package may be separate units fastened at their respective middle sections.

Referring again to FIG. 1 and further to FIG. 2, the medication dispensing system 10 may further include an educational Package Insert (slider) 40 disposed within the second portion 30 of the package. The back card 30 is open at a first end 31 and closed at a second end 35 to form a pocket 33 for retaining the slider 40. The face 26 of the front card 20 may include graphics and/or clinical information 28 relevant to medication or a redemption item in the package. In addition, the inside face 60 of the back card 30 may be configured to view clinical or educational information 100 on the slider that is relevant to the medication or redemption items contained in the package.

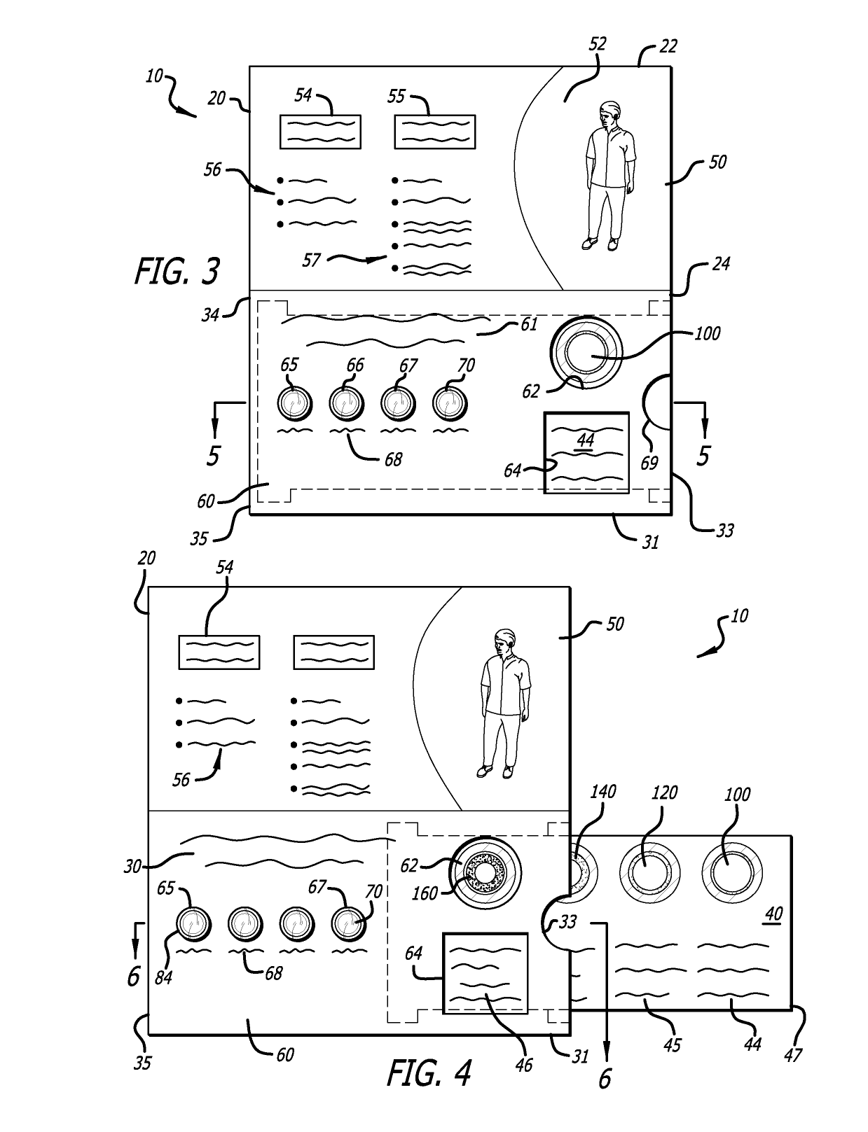

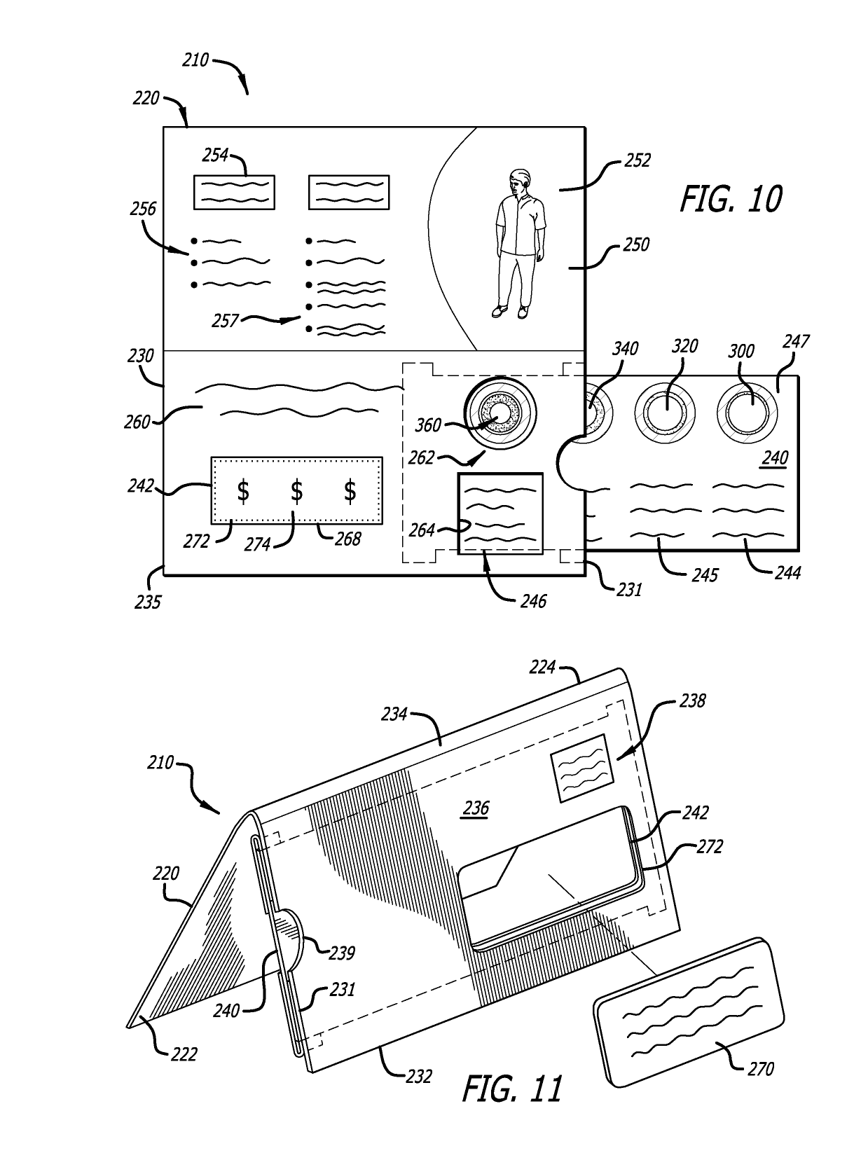

As shown in FIG. 2, the face 36 of the back card 30 may be configured with graphics and/or educational information 38 regarding medication or redemption items. The graphics and information on the different surfaces of the package may also contain clinical, dosage, advertising and company information as desired by the provider or required by regulatory agencies. The educational slider 40 is partially visible (exposed) through an opening or cutout 37 in the back face 36 of the second portion of the package. The exposed portion (outside face) 42 of the slider may also contain graphics and/or text, and is specifically configured to prevent access to the medication or redemption item when the slider is fully disposed in the pack (see FIG. 3). A groove or cutout 39 may be formed on the open edge 31 of the back card to access the slider. The groove is preferably arcuate shaped for grasping by a thumb or forefinger to move the slider so as to expose a retainer 80 of the medication (see FIGS. 4 and 7) or redemption items (see FIGS. 10 and 11).

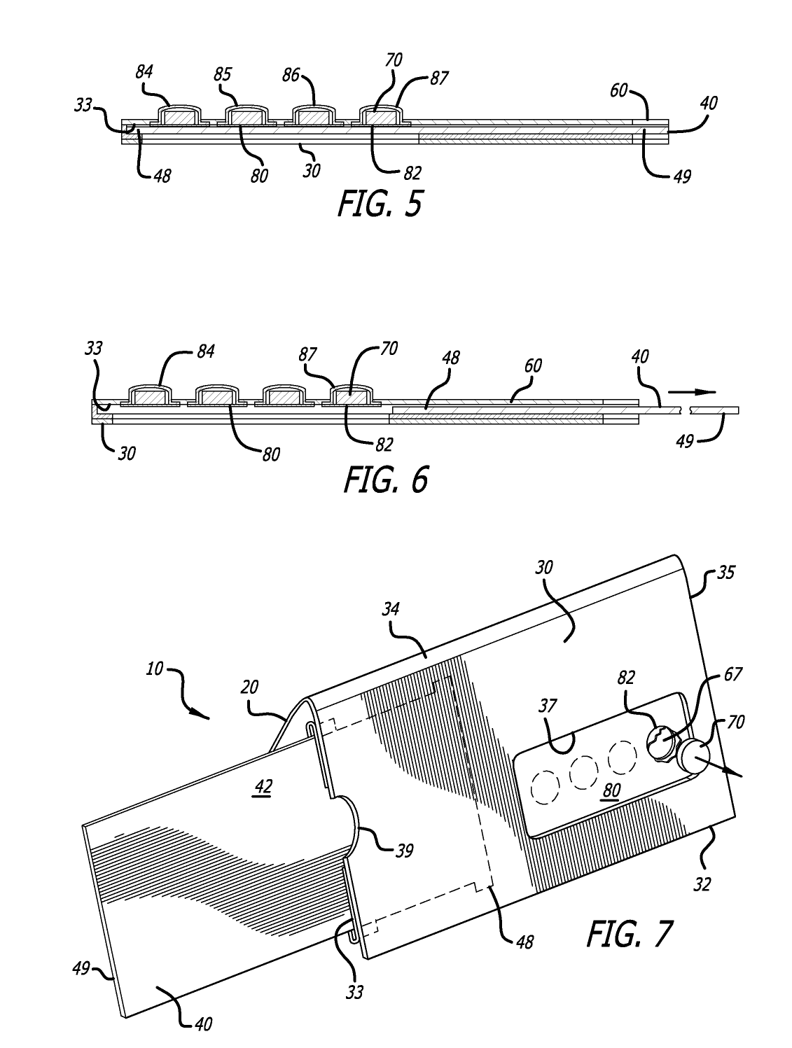

Referring further to FIG. 3, one embodiment of the dispensing system 10 configured for medication in accordance with the present invention includes an inside surface 50 of the front card 20 configured with graphics and text information 52, 54, 55 56, 57. Similarly the inside face 60 of the back card 30 may contain information text and graphics 61. The inner face of the back card is configured with a plurality of cutouts 65, 66, 67 to contain medicaments (e.g., pills, capsules and tablets) 70. Dosage or other clinical information 68 may be positioned adjacent, above or below each medication. As shown in FIG. 5, a mediation retainer system 80 having a base sheet 82 configured with a plurality of medication compartments 84, 85, 86 and 87 is retained in the pocket 33 of the second portion 30 of the packaging.

Referring again to FIG. 3, the inner face 60 of the back card 30 may further include cutouts (for example, square or circular) 62, 64 for viewing information 100, 44 on the inside face 47 of the educational slider 40. A cutout 69 is configured on the inside face 60 at the open end 35 of the second portion 30 of the package. The cutout in the inner face may be arcuate in shape and located proximate the cutout 39 (FIG. 2) on the outer face 36 of the back card 30. The two cutouts 39, 69 allow for easy grasping of the educational slider 40.

Referring now to FIG. 4, as the educational slider 40 is grasped at the two cutouts 39, 69 in the dispensing system 10, the slider may be removed from the pocket 33 in the back card 30 of the medication package. As the educational slider is moved away from the closed end 35 and though the open end 31 of the back card, additional clinical graphics 120, 140, 160 are viewable though a cutout 62 in the inside face 60 of the back card 30. Similarly, additional educational information or clinical text 45, 46 is exposed to the user though the second cutout 64.

As shown in FIG. 7, the slider may be moved outwardly with respect to the package so that the compartments 84, 85, 86, 87 (see FIGS. 5, 6) are exposed to the user, and the medication 70 may be removed by breaking the sheet 82 of the retainer system 80. The mediation retainer may be configured a so-called “blister-pack” formed from foil, plastic or other easily breakable material. A latch mechanism 48 may be configured onto the slider 40 so as to prevent the slider from fully exiting the pouch 33. For example, the latch mechanism may be configured with extending tabs (flanges) that engage tabs (flanges) near the open end 31 of the back card and within the pocket 33. Other forms of latch mechanisms are known by those of ordinary skill in the art and may be readily configured into the dispensing system of the present invention.

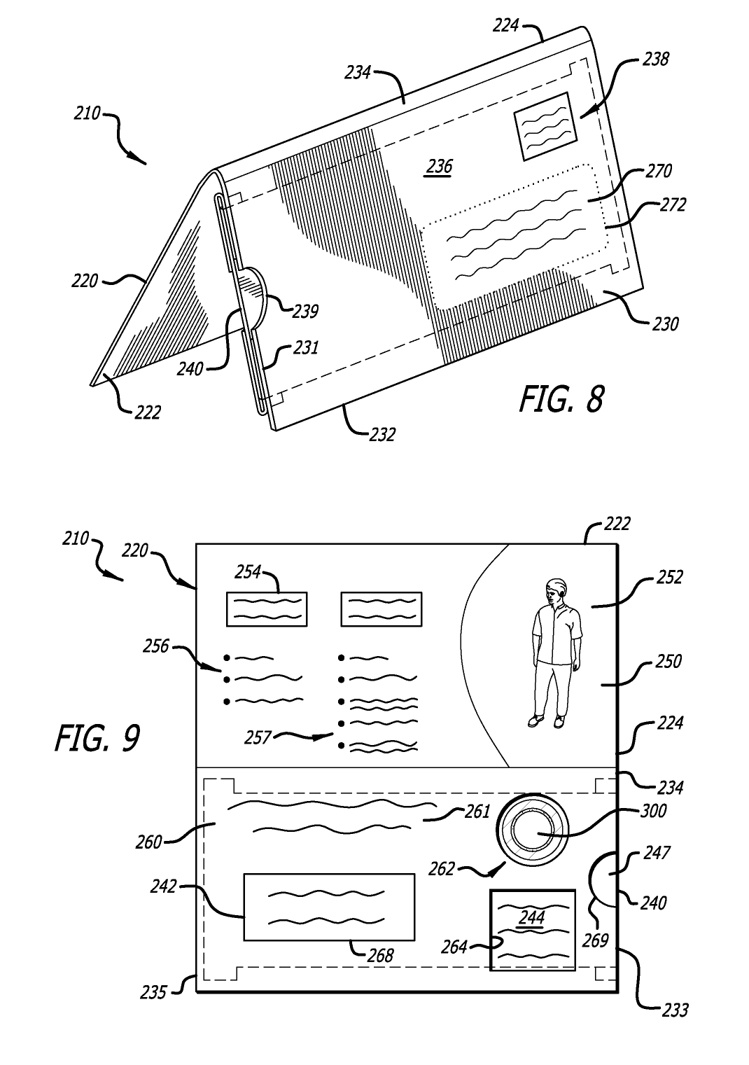

With reference to FIGS. 8-11, an alternative embodiment of the dispense system 210 of the present invention is configured to dispense price reduction coupons or other promotional items, hereinafter “redemption item(s).” As shown in FIG. 8, the dispensing system includes a package formed with a first portion (front card) 220 and a second portion (back card) 230. Similar to the embodiment in FIG. 1, the first portion of the package has a first (bottom) edge 222 and a middle section 224. The second portion of the package has a first (bottom) edge 232 and a middle section 234 transverse its bottom edge. The middle portions 224, 234 of the front card and back card are longitudinally positioned adjacent to each other. The first and second portions may be formed as a unitary body folded in the middle such that the first edge of the front card is adjacent the first edge of the back card when the package is in a closed position. Alternatively, the first and second portions of the package may be separate units fastened at their respective middle sections.

Referring to FIGS. 8 and 9, the redemption item dispensing system 210 further includes an educational Package Insert (slider) 240 disposed within the second portion 230 of the package. The back card 230 is open at a first end 231 and closed at a second end 235 to form a pocket 233 for retaining the slider 240. A groove or cutout 239 is formed on the open edge 231 of the back card to access the slider 240. The groove is preferably arcuate shaped for grasping by a thumb or forefinger to move the slider so as to expose the inside face of the redemption item (see FIGS. 9 and 10).

As further shown in FIG. 8, the face 236 of the back card 230 may be configured with graphics and/or educational information 238 regarding the medication or other product associated with the redemption item 270 (FIG. 11). The graphics and information on the different surfaces of the package, including the back of the redemption item, may contain clinical, dosage, advertising and company information (for example, written text, linear barcode, matrix barcode, two-dimensional code or other format) as desired by the provider or required by regulatory agencies.

Referring now to FIG. 9 one embodiment of redemption item dispensing system 210 of the present invention includes an inside surface 250 of the front card 220 configured with graphics and text information 252, 254, 256, 257. Similarly the inside face 260 of the back card 230 may contain information text and graphics 261. The inner face of the back card is configured with a cutout 242 to provide access to the redemption item 270 (FIG. 11). Instructions or other information 268 may be printed on the portion of the slider 240 that is visible within the window 242 when the slider is fully retained in the pocket 233 of the second portion (card) 230 of the package.

Referring again to FIG. 9 and further to FIG. 10, the inner face 260 of the back card 230 may further include one or more cutouts (for example, square or circular) 262, 264 for viewing information 300, 244 on the inside face 247 of the educational slider 240. A cutout 269 is configured on the inside face 260 at the open end 231 of the second portion 230 of the package 210. For example, the arcuate cutout in the inner face is located proximate the cutout 239 on the outer face 236 of the back card 230 (see FIG. 8). The two cutouts 239, 269 allow for easy grasping of the educational slider 240.

Referring again to FIG. 10 and follow-up to FIG. 11, as the educational slider 240 is grasped at the two cutouts 239, 269, the slider may be removed from the pocket 233 in the back card 230 of the dispensing system 210. As the educational slider is moved away from the closed end 235 of the back card and though the open end 231, additional clinical graphics 320, 340, 360 are viewable though the cutout 262 in the inside face 260 of the back card 230. Similarly, additional educational information or clinical text 245, 246 is exposed to the user though the second cutout 264. Similarly, the front face 274 of the redemption item 270 is exposed. The redemption item and may be removed by applying pressure to its front face 274, thereby breaking the perforations 272. Alternatively, pressure to the redemption item may be applied from the outer face 236 of the back card 230 to remove the redemption item 270 so as to break the perforations 272. Other embodiments in accordance with the present invention (for example, but not limited to, a peel-away coupon) may be employed as is known to those skilled in the art of designing and/or manufacturing such packaging and promotional materials.

Those skilled in the art of packaging and dispensing systems can determine, without undue experimentation, the appropriate geometries, materials, and other features of the outer package and internal slider. Similarly, those skilled in the art can determine, without undue experimentation, the appropriate geometries, materials and other features of the medication retaining and redemption item portions of the dispensing system. For example, the package and educational slider may be formed from paper, card stock, plastic or metal. The medication retainer material may be made from metal foil (for example, aluminum, tin), paper, rubber or plastic. The packaging may be printed, coated, embossed, silkscreen or laminated (for example, lenticular) so as to provide the dosage instruction and other clinical and promotional information.

While particular forms of the invention have been illustrated and described with regard to certain embodiments of medication and redemption item dispensing systems, it will also be apparent to those skilled in the art that various modifications can be made without departing from the scope of the invention. More specifically, it should be clear that the present invention is not limited to any particular method of forming the outside package or inside insert and mediation retainer. While certain aspects of the invention have been illustrated and described herein in terms of its use with foil blister-packs and other specific materials, it will be apparent to those skilled in the art that any suitable materials may be used that are not specifically discussed herein. Further, any particular sizes and dimensions of the dispensing system that have been described or inferred herein and are provided as examples only. Other modifications and improvements may be made without departing from the scope of the invention. Accordingly, it is not intended that the invention be limited beyond the intended scope of the invention, for example, but not limited to, the appended claims.

We claim:

1. A system for dispensing, the system comprising:
a package having a first portion and a second portion, wherein the first portion is configured to be moved adjacent the second portion, and wherein the second portion is configured with a first opening and a first window;
a slider disposed within the second portion of the package; and
a retainer disposed within the second portion of the package, wherein the slider is configured to be moved through the first opening so as to allow at least one item to be removed from the retainer through the first window.

2. The system for dispensing of claim 2, wherein the second portion is configured with a pocket for retaining the slider.

3. The system for dispensing of claim 3, wherein the slider and pocket are configured with a latch mechanism to prevent the slider from being removed from the pocket.

4. The system for dispensing of claim 1, wherein the at least one item includes a medication.

5. The system for dispensing of claim 4, wherein the retainer is configured as a blister-pack.

6. The system for dispensing of claim 4, wherein the slider is configured with educational information relating to the medication.

7. The system for dispensing of claim 6, wherein the second portion of the package is configured with a second window, and wherein the slider is configured to provide educational information relating to the medication viewable though the second window.

8. A method for dispensing medication, the method comprising:
providing a package having a first portion and a second portion, wherein the first portion is configured to be moved adjacent the second portion, and wherein the second portion is configured with a first opening and a first window;
providing a slider disposed within the second portion of the package;
retaining mediation within the second portion of the package;
moving the slider through the first opening; and
removing the mediation through the first window.

9. The method for dispensing medication of claim 8, further including retaining the mediation in a blister-pack and breaking the blister-pack after the slider is moved through the first opening.

10. A system for dispensing a promotional item, the system comprising:
a package having a first portion and a second portion, wherein the first portion is configured to be moved adjacent the second portion, and wherein the second portion is configured with a first opening and a first window;
a slider disposed within the second portion of the package; and
a promotional item disposed within the second portion of the package, wherein the slider is configured to be moved through the first opening so as to allow the promotional item to be removed through the first window.

11. The system for dispensing of claim 10, wherein the second portion is configured with a pocket for retaining the slider.

12. The system for dispensing of claim 11, wherein the slider and pocket are configured with a latch mechanism to prevent the slider from being removed from the pocket.

13. The system for dispensing of claim 10, wherein the second portion is configured with a perforation for removably retaining the promotional item.

14. The system for dispensing of claim 13, wherein the promotional item includes information relevant to a medication.

15. The system for dispensing of claim 14, wherein the promotional item includes a redemption item.

16. The system for dispensing of claim 15, wherein the redemption item includes a price discount coupon.
